(19) United States
(12) Patent Application Publication
(10) Pub. No.: US 2016/0204550 A1
(43) Pub. Date: Jul. 14, 2016

(54) CABLE CONNECTOR RETENTION SUPPORT SYSTEM

(71) Applicant: William H. Jennings, Huddleston, VA (US)

(72) Inventor: William H. Jennings, Huddleston, VA (US)

(21) Appl. No.: 14/992,349

(22) Filed: Jan. 11, 2016

Related U.S. Application Data
(60) Provisional application No. 62/101,709, filed on Jan. 9, 2015.

(51) Int. Cl. H01R 13/639

(52) U.S. Cl. CPC H01R 13/639

(57) ABSTRACT

A cable connector retention fastener is provided which prevents accidental disengagement of an accessory device, such as a speaker mic connector, from a device, such as a smartphone or walkie-talkie. An elongated fastening strap includes multiple loop portions on a front side, and has a flat, smooth surface on its back side. The fastening strap further includes a wide head at one end thereof defining a slot so that a tail end of the strap can be inserted through the slot for securely wrapping the strap around a cable and/or connector. Further, a fastening member has multiple hook portions on a front side, and includes a high strength adhesive on its back side. The fastening member may comprise a geometric shaped pad and is adapted to secure to a surface, such as the back of the smartphone or walkie-talkie, by adhesively bonding the back side of the fastening member thereto.

### FIELD OF THE INVENTION

The present invention relates to a cable connector retention support system for reducing or eliminating connector damage, eliminating accidental connector disengagement from a device, such as a smartphone, tablet, walkie-talkie or other portable device, and preventing loss of the device.

### BACKGROUND

Conventional fastener straps are typically used to bundle multiple cables and cord-like materials, such as wires, electrical cords and telephone cables. Such conventional straps are often wrapped tightly around a portion of the bundled cables and cinched to secure the cables together. These conventional straps are sometimes provided with hook and loop type securing means, such as Velcro™, on each side thereof to keep the wrapped bundle tight in order to prevent cables from slipping out. This type of securing means allows the strap to be rolled up so that a front side thereof releasably engages an opposite back side of the strap to secure and maintain the cables in the bundled formation.

A significant problem exists with devices that utilize a simple audio jack to interface to audio accessories, e.g. speaker microphones, since an accessory connector is not positively captivated to the device. Consequently, during normal use, the connector will very easily and readily become disengaged from the device, causing loss of functionality and communication between the device and the audio accessory. Further, the stresses which the accessory connector impose on the device mating connector can cause damage, thus resulting in premature failure of the device connector as well as the accessory connector.

### SUMMARY

The present invention provides a cable connector retention fastener configured to secure a cable of an accessory device, such as a speaker microphone, to a communication device, such as a smartphone or walkie-talkie. The cable retention fastener comprises a fastening member having a first surface and an opposite second surface. The first surface is configured to be securely attached to a support structure such as a handheld device, portable electronic device, portable communications device, computer rack, joist or pillar, among others. The second surface defines an engaging surface. An elongated fastening strap includes a first surface and an opposite second surface, wherein the first surface defines a non-engaging surface and the second surface defines an engaging surface configured to releasably and securely engage the engaging surface of the fastening member. The elongated fastening strap further includes a head portion provided at one end thereof, a tail portion provided at an opposite second end thereof, and an elongated body portion provided between the head portion and the tail portion. The head portion comprises a receiving slot configured to receive the body portion and the tail portion for cinching an accessory device cable when the fastening strap is securely wrapped around the cable, such that the fastening strap tethers the cable to the fastening member.

The engaging surface of the fastening member includes a plurality of hook elements, and the engaging surface of the fastening strap includes a plurality of corresponding loop elements. Also, the first surface of the fastening member comprises an adhesive for bonding to the support structure, wherein the adhesive first surface of the fastening member is releasably attached to a low tact carrier member in order to retain its adhesiveness.

The fastening member may be a flat substantially rectangular pad, such that a width of the fastening member is greater than a width of the body portion of the fastening strap for accommodating alignment tolerance. The fastening member may alternatively be a flat pad having an elliptical shape, a rectangular shape with full radii or other geometric shape. Additionally, the non-engaging surface of the fastening strap is smooth, so that an indicia may be provided thereon.

The cable connector retention fastener eliminates the problem of accidental disengagement of a speaker mic connector from the device, which is desired for use in police, fire, EMT, heavy industrial and military applications, among others. Further, the cable connector retention fastener greatly reduces or eliminates any applied stress to the device connector from the speaker mic connector resulting from tensile loading of the cable, thus preventing damage and/or failure of the device connector. Additionally, loss of the device due to accidental disengagement is prevented since the cable connector retention fastener acts as a tether to secure the device to the accessory device cable.

### BRIEF DESCRIPTION OF THE DRAWINGS

Various advantages, features and functions of the present invention will become readily apparent and better understood in view of the following description and accompanying drawings. The following description is not intended to limit the scope of the present invention, but instead merely provides exemplary embodiments for ease of understanding.

FIG. 1 is a top plan view of a cable connector retention fastener according to the present invention.

FIG. 2 is a bottom plan view of a fastening strap of the cable connector retention fastener of FIG. 1.

FIG. 3 is a top plan view the fastening strap of the cable connector retention fastener of FIG. 1.

FIG. 4 is a top plan view of a plurality of fastening members of the present invention.

FIG. 5 is a perspective view of the plurality of fastening members of FIG. 4.

FIG. 6 is top plan view of a kit comprising a plurality of fastening members and fastening straps of the present invention.

FIG. 7 is a front elevation view of the cable connector retention fastener in use secured to a back side of a smartphone device and tethered to an accessory device cable.

FIG. 8 is an enlarged partial view of the cable connector retention fastener of FIG. 7.

FIG. 9 is a rear elevation view of the cable connector retention fastener of FIG. 7.

FIG. 10 is a partial view of the cable connector retention fastener of FIG. 7 during use when the accessory device cable is pulled taut.

It should be noted that the drawing figures are not necessarily drawn to scale, but instead are drawn to provide a better understanding of the components thereof, and are not intended to be limiting in scope, but rather to provide exemplary illustrations. It should further be noted that the figures illustrate exemplary configurations of the present invention, and in no way limit the structures or configurations thereof according to the present disclosure.

### DETAILED DESCRIPTION

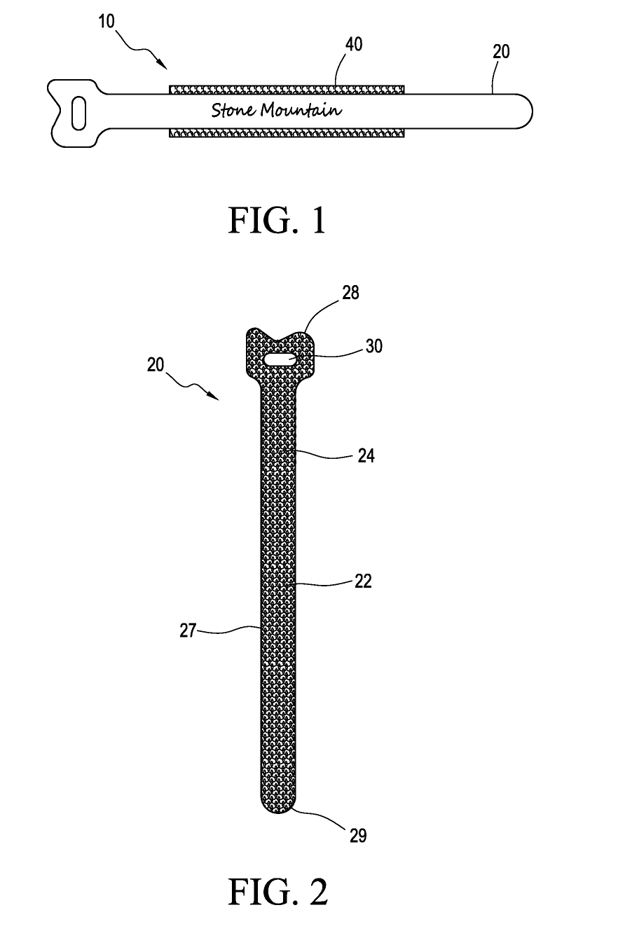

Referring to FIG. 1, a cable connector retention fastener 10 comprises an elongated fastening strap 20 releasably engaged with a fastening member 40 by means of a hook and loop arrangement, such as Velcro™ and other similar material that provides a means for creating a releasable engagement bond. Both the fastening strap and the fastening member are constructed from respective flat sheets of material.

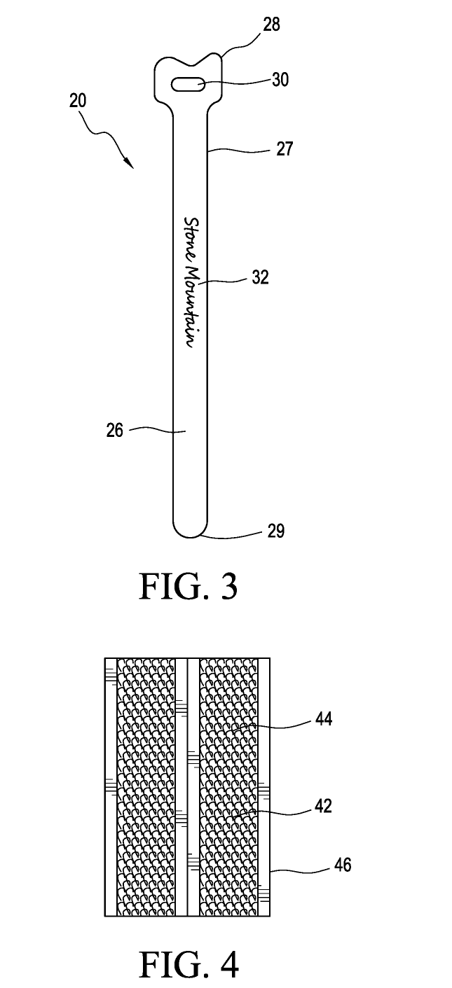

As illustrated in FIG. 2, the fastening strap 20 comprises an elongated body portion 27, a head portion 28 provided at one end of the body portion, and a tail portion 29 provided at an opposite end of the body portion. The fastening strap 20 includes a front side defining an engaging surface 24 having multiple loop elements 22. The engaging surface 24 may extend from the head portion 28 through the tail portion 29, such that the plurality of loop elements 22 covers the entire front side of the fastening strap 20. As illustrated in FIG. 3, the fastening strap 20 also includes a back side defining a non-engaging surface 26 having a flat, smooth finish. The flat, smooth non-engaging surface 26 is configured so that an indicia or a graphic design 32, such as artwork, a company logo, instructions, product certification information, etc., may be applied thereto. The smooth surface of the back side of the fastening strap allows such a graphic design 32 to be easily applied thereto, and also helps decrease manufacturing costs compared to conventional straps which have hook portions on one side and corresponding loop portions on an opposite side thereof. For instance, artwork may be acrylic silkscreened on any part of the non-engaging surface on the back side of the fastening strap.

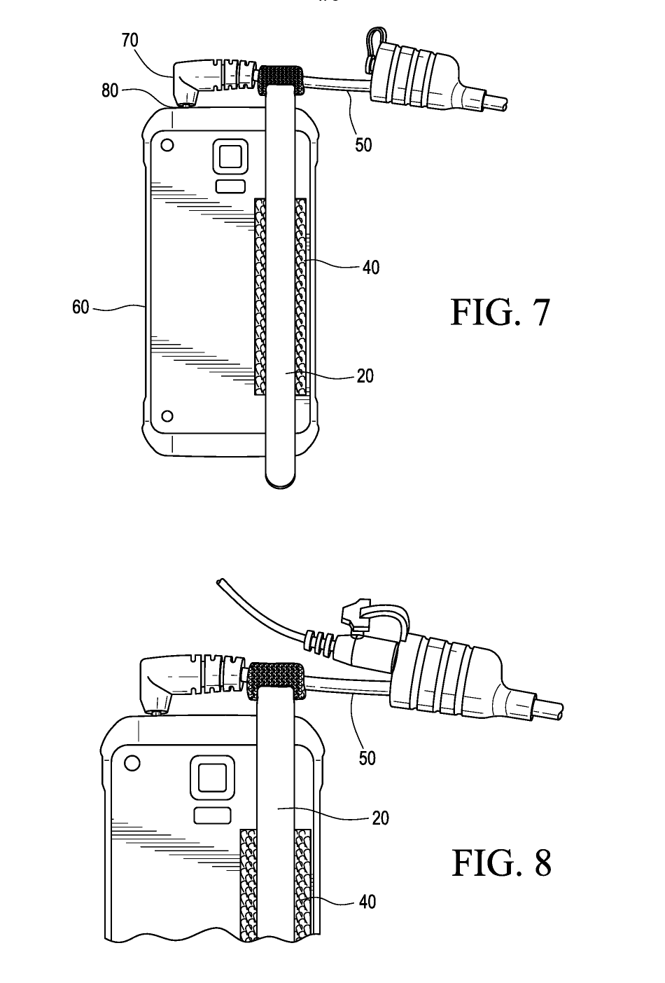

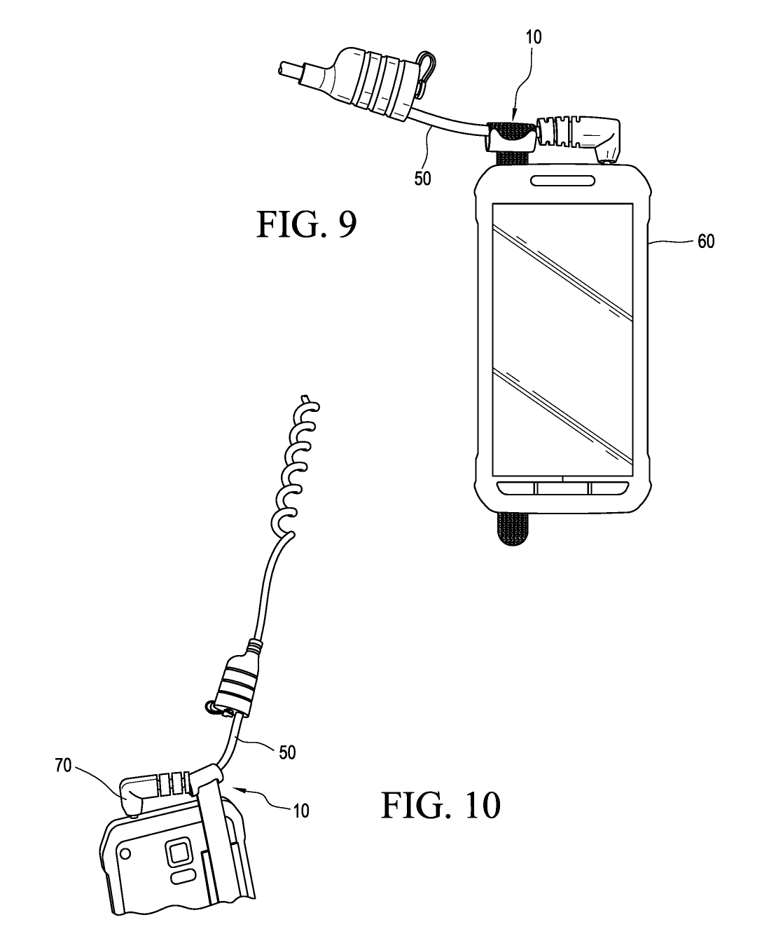

The width of the head portion 28 of the fastening strap 20 is greater than both the width of the body portion 27 and the width of the tail portion 29. The width of the body portion 27 may be the same as the width of the tail portion 29. Alternatively, the width of the tail portion 29 may be smaller than the width of the body portion 27. Further, the head portion 28 includes a receiving slot 30 configured to receive both the body portion 27 and the tail portion 29. In use, the body portion 27 of the fastening strap is first wrapped around a cable and/or a cable connector, and then the tail portion 29 is inserted through the receiving slot 30. The body and tail portions are then tightly pulled through the head portion 28 in order to cinch the cable and/or connector, as illustrated in FIGS. 7-9. The lack of hook geometry on the non-engaging surface 26 on the back side of the fastening strap 20 greatly facilitates the installation of the strap to a cable by eliminating interference mating with the engaging surface 24 on the front side of the fastening strap due to hook and loop geometry, which exists with conventional straps.

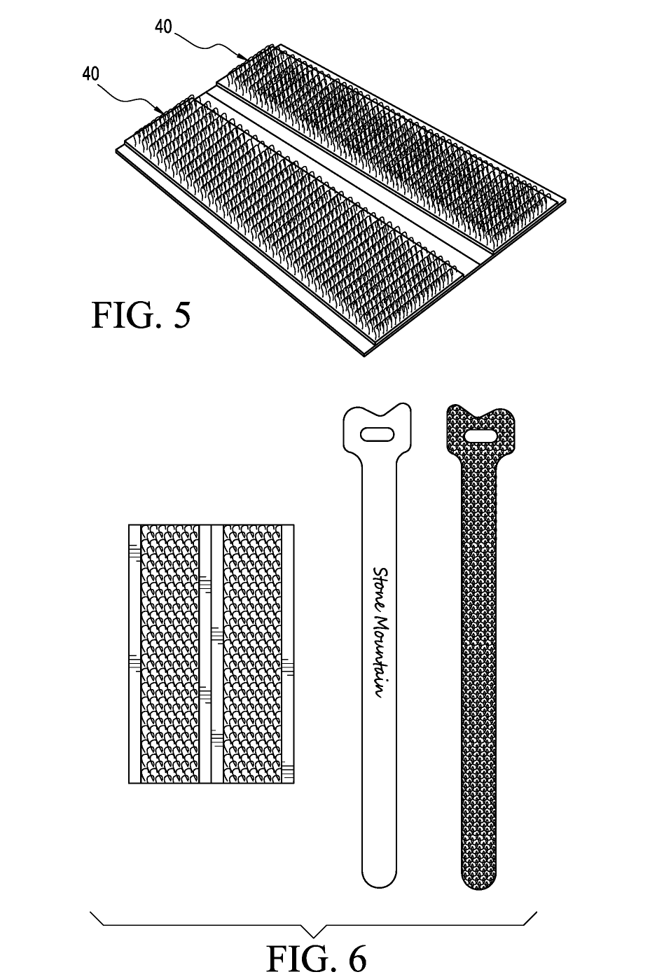

Referring to FIGS. 4-5, a plurality of fastening members 40 are shown, wherein each individual fastening member 40 comprises a front side defining an engaging surface 44 having multiple hook elements 42 corresponding to the multiple loop elements 22 of the fastening strap 20. The fastening member 40 further comprises an opposite back side having a high strength adhesive applied thereto for adhesively bonding to a surface of an object or support structure, such as a portable device or casing of a portable device, as will be described in detail later. The fastening member 40 is initially adhered to a carrier member 46, such as a low tack film substrate, so that when a user peels the fastening member off the carrier member, the back side of the fastening member retains a strong adhesiveness. Moreover, referring to FIG. 6, a kit may be provided comprising a plurality of fastening straps 20 and a plurality of fastening members 40.

Turning to FIGS. 7-9, the fastening member 40 may be rectangular in shape, and is configured to secure to a surface of an object or support structure 60, such as the back of a smartphone, walkie-talkie, tablet or other portable electronic or communications device or casing thereof, by adhesively bonding the back side of the fastening member 40 thereto. It should be appreciated that the adhesive may be a strong pressure sensitive adhesive, such as a high strength acrylic, SML engineering approved equivalent or other alternative adhesive substrate. Further, the fastening member 40 is significantly wider than the fastening strap 20 in order to accommodate alignment tolerance, thus ensuring that 100% of the fastening strap 20 available to interface to the fastening member 40 will indeed make contact.

Once the fastening strap 20 is tightly wrapped around a cable 50 of an accessory device, such as a speaker microphone, the loop elements 22 of the fastening strap releasably engage with the corresponding hook elements 42 of the fastening member 40 in order to keep the cinched fastening strap 20 taut and to secure the cable 50 to the smartphone device 60. The retention fastener 10 is therefore configured to provide strain relief to the cable 50 and/or a cable connector 70 of the accessory device, especially when the cable is pulled as shown in FIG. 10. This configuration prevents damage to both the cable 50 and the cable connector 70, as well as to a device connector 80 of the smartphone device 60. Moreover, accidental disengagement of the accessory device from the smartphone is also prevented. Furthermore, loss of the device is prevented since the accessory device cable 50 acts as a tether to prevent the smartphone device from being lost due to disengagement between the cable connector 70 and the device connector 80.

The retention fastener 10 allows the cable 50 to be pulled with no loss of connectivity and no undue stresses placed upon the speaker mic connector 70 and a device connector 80. For instance, the speaker mic connector 70 may be a 3.5 mm connector having a male connection part which plugs into the device connector 80, which is a corresponding female connection part on the smartphone 60. Both the hook portion and the loop portion are rugged and have excellent mated retention sufficient to withstand, for example, a 5.0 kg shear load minimum. The retention fastener eliminates the problem of accidental disengagement of a speaker mic connector from the device, which is desired for use in police, fire, EMT, heavy industrial and military applications, among others. Further, the retention fastener greatly reduces or eliminates any applied stress to the device connector from the speaker mic connector resulting from tensile loading of the cable, thus preventing damage and/or failure of the device connector. Additionally, the retention fastener greatly reduces or eliminates any applied stress to the speaker mic connector resulting from tensile loading of the cable, preventing damage and/or failure of the speaker mic connector.

What is claimed is:

1. A cable connector retention fastener comprising:
a fastening member having a first surface and an opposite second surface, wherein the first surface is configured to be securely attached to a support structure and the second surface defines an engaging surface;
an elongated fastening strap having a first surface and an opposite second surface, wherein the first surface defines a non-engaging surface and the second surface defines an engaging surface configured to releasably and securely engage the engaging surface of the fastening member;
wherein the elongated fastening strap further includes a head portion provided at one end thereof, a tail portion provided at an opposite second end thereof, and an elongated body portion provided between the head portion and the tail portion; and
wherein the head portion comprises a receiving slot configured to receive the body portion and the tail portion for cinching an accessory device cable when the fastening strap is securely wrapped around the cable, such that the fastening strap tethers the cable to the fastening member.

2. The cable connector retention fastener according to claim 1, wherein the support structure is a casing of a portable handheld device, and wherein the fastening member is fixed to a surface of the casing of the portable handheld device.

3. The cable connector retention fastener according to claim 1, wherein the engaging surface of the fastening member includes a plurality of hook elements, and the engaging surface of the fastening strap includes a plurality of corresponding loop elements.

4. The cable connector retention fastener according to claim 3, wherein the plurality of hook elements cover the entire surface of the engaging surface of the fastening member, and the plurality of loop elements cover the entire engaging surface of the fastening strap.

5. The cable connector retention fastener according to claim 1, wherein the first surface of the fastening member comprises an adhesive for bonding to the support structure.

6. The cable connector retention fastener according to claim 5, wherein the adhesive first surface of the fastening member is releasably attached to a low tact carrier member.

7. The cable connector retention fastener according to claim 1, wherein the fastening member is a flat substantially rectangular pad.

8. The cable connector retention fastener according to claim 7, wherein a width of the fastening member is greater than a width of the body portion of the fastening strap for accommodating alignment tolerance.

9. The cable connector retention fastener according to claim 1, wherein the non-engaging surface of the fastening strap is smooth.

10. The cable connector retention fastener according to claim 1, wherein the fastening strap and the fastening member are each constructed from respective flat sheets of material.

11. The cable connector retention fastener according to claim 1, wherein the non-engaging surface of the fastening strap comprises an indicia.

12. A kit for securing an accessory device cable to a device, comprising a plurality of cable connector retention fasteners as set forth in claim 1.

13. A cable connector retention fastener comprising:
a fastening member having a first surface and an opposite second surface, wherein the first surface is configured to be securely attached to a support structure and the second surface defines an engaging surface;
an elongated fastening strap having a first surface and an opposite second surface, wherein the first surface defines a non-engaging surface and the second surface defines an engaging surface configured to releasably and securely engage the engaging surface of the fastening member;
wherein that the fastening strap tethers an accessory device cable to the fastening member when the fastening member is attached to the support structure, such that disengagement of a cable connector of the accessory device cable from a device connector of the support structure is prevented when the accessory device cable is pulled taut.

14. The cable connector retention fastener according to claim 13, wherein the engaging surface of the fastening member includes a plurality of hook elements, and the engaging surface of the fastening strap includes a plurality of corresponding loop elements.

15. The cable connector retention fastener according to claim 13, wherein the first surface of the fastening member comprises an adhesive for bonding to the support structure.

16. The cable connector retention fastener according to claim 15, wherein the adhesive first surface of the fastening member is releasably attached to a low tact carrier member.

17. The cable connector retention fastener according to claim 13, wherein the elongated fastening strap further includes a head portion having a receiving slot provided at one end thereof, a tail portion provided at an opposite second end thereof, and an elongated body portion provided between the head portion and the tail portion.

18. The cable connector retention fastener according to claim 17, wherein the fastening member is a flat substantially rectangular pad.

19. The cable connector retention fastener according to claim 18, wherein a width of the fastening member is greater than a width of the body portion of the fastening strap for accommodating alignment tolerance.

20. The cable connector retention fastener according to claim 13, wherein the non-engaging surface of the fastening strap is smooth and comprises an indicia.
